(19) United States
(12) Patent Application Publication
(10) Pub. No.: US 2023/0311588 A1
(43) Pub. Date: Oct. 5, 2023

(54) HEAVY DUTY PNEUMATIC TIRE

(71) Applicant: Sumitomo Rubber Industries, Ltd., Kobe-shi (JP)

(72) Inventor: Satoko TSUJIBAYASHI, Kobe-shi (JP)

(73) Assignee: Sumitomo Rubber Industries, Ltd., Kobe-shi (JP)

(21) Appl. No.: 18/127,687

(22) Filed: Mar. 29, 2023

(30) Foreign Application Priority Data
Mar. 30, 2022 (JP) 2022-057053

(51) Int. Cl. B60C 15/06; B60C 11/03

(52) U.S. Cl. CPC B60C 15/0628; B60C 11/03; B60C 2011/0341; B60C 2200/06

(57) ABSTRACT

A heavy duty pneumatic tire can have, in each shoulder land portion, a plurality of holes extending from an outer surface thereof toward a belt. The tire can include a fiber reinforcing layer including a relatively large number of fiber cords aligned with each other and formed from a nylon fiber. The fiber reinforcing layer can include an inner fiber reinforcing layer and an outer fiber reinforcing layer. The inner fiber reinforcing layer can cover an outer end of a steel reinforcing layer from an outer side in an axial direction, and the outer fiber reinforcing layer can cover an outer end of the inner fiber reinforcing layer from the outer side in the axial direction.

### CROSS-REFERENCE TO RELATED APPLICATION(S)

The present application claims priority to Japanese pat. application JP 2022-057053, filed on Mar. 30, 2022, the entire contents of which is incorporated herein by reference in its entirety.

### BACKGROUND

### Field

The disclosure relates to a heavy duty pneumatic tire.

### Background Art

The tread of a heavy duty pneumatic tire has a relatively large volume. In particular, each shoulder portion has a relatively large volume, and heat is less likely to be transmitted thereto. Therefore, a vulcanization time required to form each shoulder portion of the heavy duty pneumatic tire can be a rate-limiting factor for a vulcanization reaction. Therefore, it has been proposed to shorten the vulcanization time by performing vulcanization with heat conductors inserted in the shoulder portion (for example, Japanese Laid-Open Pat. Publication No. 2020-116976).

Meanwhile, in the case where holes into which the heat conductors are inserted are formed in the tread during production, the stiffness near each hole is decreased in the completed tire, so that local wear (also referred to as spot wear in the present specification) may occur near the hole. If such spot wear around the hole occurs, trapping of a stone or catching of a projecting object in the hole is promoted. In particular, under use conditions where a lateral force is likely to be applied, cracking may be caused by a force being applied outward in the tire width direction in a state where a stone or a projecting object is trapped in the hole, so that chipping starting from the hole or damage (also referred to as rib tear) with tearing of a land portion in a shoulder portion may occur.

### SUMMARY

A heavy duty pneumatic tire according to an aspect of the present disclosure can include:
a pair of beads each having a core extending in a circumferential direction;
a carcass including a carcass ply having a body portion extending between one core and the other core and a pair of turned-up portions connected to the body portion and turned up around the cores from an inner side toward an outer side in an axial direction, the carcass ply including a plurality of carcass cords aligned with each other;
a tread radially outward of the body portion;
a belt radially outward of the body portion and radially inward of the tread;
a steel reinforcing layer turned up around the core, having an inner end inward of the body portion in the axial direction and an outer end outward of the turned-up portion in the axial direction, and including a plurality of steel cords aligned with each other; and
a fiber reinforcing layer including a plurality of fiber cords aligned with each other, wherein
at least three circumferential grooves are formed on the tread so as to be aligned in the axial direction, whereby at least four land portions are formed therein so as to be aligned in the axial direction,
among the at least three circumferential grooves, a circumferential groove located on each outermost side in the axial direction is a shoulder circumferential groove,
among the at least four land portions, a land portion located on each outermost side in the axial direction is a shoulder land portion,
a plurality of holes are in the shoulder land portion so as to extend from an outer surface thereof toward the belt,
each of the fiber cords is made from a nylon fiber,
the fiber reinforcing layer includes an inner fiber reinforcing layer on an innermost side in the axial direction and an outer fiber reinforcing layer on the outermost side in the axial direction,
the inner fiber reinforcing layer covers an outer end of the steel reinforcing layer from the outer side in the axial direction, and
the outer fiber reinforcing layer covers an outer end of the inner fiber reinforcing layer from the outer side in the axial direction.

In the heavy duty pneumatic tire, a distance WH from each hole to an outer end of the shoulder land portion can be not less than 0.12 times and not greater than 0.88 times a maximum width WS in the axial direction of the shoulder land portion.

In the heavy duty pneumatic tire, a depth DH of each hole can be not less than ⅓ times and not greater than 1 times a depth DS of the shoulder circumferential groove.

In the heavy duty pneumatic tire, an outer end of the outer fiber reinforcing layer can be outward of an end of the turned-up portion in a radial direction, and a distance H4 in the radial direction to the outer end of the outer fiber reinforcing layer can be not less than 1.4 times and not greater than 1.8 times a distance H3 in the radial direction to the end of the turned-up portion.

In the heavy duty pneumatic tire, the outer end of the inner fiber reinforcing layer can be inward of the outer end of the outer fiber reinforcing layer in the radial direction,
a distance in the radial direction to the outer end of the inner fiber reinforcing layer can be smaller than a distance in the radial direction to the outer end of the outer fiber reinforcing layer, and
a difference L1 therebetween can be not less than 10 mm and not greater than 15 mm.

In the heavy duty pneumatic tire, the number of the fiber cords in the fiber reinforcing layer can be not less than 20 and not greater than 70 per 50 mm width of the fiber reinforcing layer.

In the heavy duty pneumatic tire, the fiber cords in the inner fiber reinforcing layer can be tilted relative to the carcass cords,
the fiber cords in the outer fiber reinforcing layer can be tilted relative to the carcass cords in a direction opposite to that of the fiber cords in the inner fiber reinforcing layer,
an intersection angle between each fiber cord in the inner fiber reinforcing layer and each carcass cord can be not less than 40 degrees and not greater than 80 degrees, and
an intersection angle between each fiber cord in the outer fiber reinforcing layer and each carcass cord can be not less than 40 degrees and not greater than 80 degrees.

In the heavy duty pneumatic tire, the fiber cords in the inner fiber reinforcing layer can be tilted relative to the carcass cords,
the fiber cords in the outer fiber reinforcing layer can be tilted relative to the carcass cords in a direction opposite to that of the fiber cords in the inner fiber reinforcing layer, and
an intersection angle between each fiber cord in the inner fiber reinforcing layer and each fiber cord in the outer fiber reinforcing layer can be not less than 80 degrees and not greater than 160 degrees.

### BRIEF DESCRIPTION OF THE DRAWINGS

FIG. 1 is a cross-sectional view showing a part of a heavy duty pneumatic tire according to one or more embodiments of the present disclosure;

FIG. 2 is a development showing a tread surface of the tire in FIG. 1;

FIG. 3 is a cross-sectional view showing a part of a tread portion of the tire in FIG. 1;

FIG. 4 illustrates an arrangement state of carcass cords, steel cords, and fiber cords in a bead portion of the tire in FIG. 1;

FIG. 5 is a cross-sectional view showing the bead portion of the tire in FIG. 1;

FIG. 6 is a cross-sectional view showing an example of a hole provided in a shoulder land portion of the tire in FIG. 1;

FIG. 7 is a cross-sectional view showing another example of the hole provided in the shoulder land portion of the tire in FIG. 1;

FIG. 8 is a cross-sectional view showing still another example of the hole provided in the shoulder land portion of the tire in FIG. 1; and

FIG. 9 illustrates a production state of the tire in FIG. 1.

### DETAILED DESCRIPTION

Hereinafter, the present invention will be described in detail based on preferred embodiments with appropriate reference to the drawings.

Embodiments of the present disclosure are disclosed at least in view of the above circumstances in the Background section, and an object of the present disclosure, among one or more objects, is to provide a heavy duty pneumatic tire that can suppress occurrence of spot wear around each hole to suppress occurrence of rib tear or chipping starting from the hole, while achieving shortening of a vulcanization time.

Generally, embodiments of the present disclosure can involve a technology to suppress occurrence of spot wear in a completed tire or occurrence of land portion tear or chipping starting from a hole, while adopting a production method in which a vulcanization time is shortened by performing vulcanization in a state where a heat conductor is inserted into a shoulder portion, and as a result, the present inventor has found that the above-described object can be achieved by providing a predetermined reinforcing layer in a bead portion.

In a heavy duty pneumatic tire according to one or more embodiments of the present disclosure, since a plurality of holes can be provided in the shoulder land portion, and the fiber reinforcing layer for which fiber cords formed from a nylon fiber are used can be provided in a bead portion, it can be possible to suppress occurrence of spot wear around each hole to suppress occurrence of rib tear or chipping with the hole as a starting point, while achieving shortening of a vulcanization time.

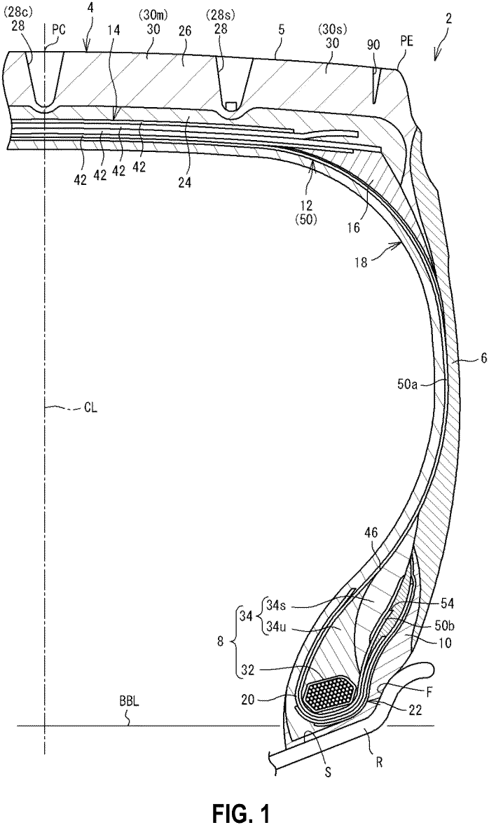

Turning to the figures, FIG. 1 shows a part of a heavy duty pneumatic tire 2 (hereinafter, sometimes referred to simply as “tire 2”) according to an embodiment of the present disclosure. The tire 2 can be mounted to a heavy duty vehicle such as a truck and a bus, for example.

FIG. 1 shows a part of a cross-section (also referred to as meridian cross-section) of the tire 2 along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is the circumferential direction of the tire 2. In FIG. 1, an alternate long and short dash line CL represents the equator plane of the tire 2.

In FIG. 1, the tire 2 is fitted on a rim R. The rim R can be a standardized rim. The interior of the tire 2 can be filled with air, and the internal pressure of the tire 2 can be adjusted to a standardized internal pressure. No load is applied to the tire 2.

According to one or more embodiments of the present disclosure, a state where the tire 2 is fitted on the rim R (standardized rim), the internal pressure of the tire 2 can be adjusted to a standardized internal pressure, and no load is applied to the tire 2 can be referred to as a standardized state. In one or more embodiments of the present disclosure, unless otherwise specified, the dimensions and angles of the tire 2 and each member of the tire 2 are measured in the standardized state.

The dimensions and angles of each component in a meridian cross-section of the tire, which cannot be measured in a state where the tire is fitted on the standardized rim, can be measured in a cross-section of the tire obtained by cutting the tire along a plane including a rotation axis, with the distance between right and left beads being made equal to the distance between the beads in the tire that is fitted on the standardized rim.

In the present specification, the standardized rim can be regarded as a rim specified in a standard on which the tire 2 is based. The “standard rim” in the JATMA standard, the “Design Rim” in the TRA standard, and the “Measuring Rim” in the ETRTO standard are examples of standardized rims.

In the present disclosure, the standardized internal pressure can be regarded as an internal pressure specified in the standard on which the tire 2 is based. The “highest air pressure” in the JATMA standard, the “maximum value” recited in the “TIRE LOAD LIMITS AT VARIOUS COLD INFLATION PRESSURES” in the TRA standard, and the “INFLATION PRESSURE” in the ETRTO standard are examples of standardized internal pressures.

In the present disclosure, the standardized load can be regarded as a load specified in the standard on which the tire 2 is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard are examples of standardized loads.

In FIG. 1, a solid line BBL extending in the axial direction is representative of a bead base line. This bead base line BBL can be regarded as a line that defines the rim diameter (see JATMA or the like) of the rim R (standardized rim).

The tire 2 can include a tread 4, a pair of sidewalls 6, a pair of beads 8, a pair of chafers 10, a carcass 12, a belt 14, a pair of cushion layers 16, an inner liner 18, a pair of reinforcing layers 20 (e.g., steel reinforcing layers), and a pair of fiber reinforcing layers 22.

The tread 4 can come into contact with a road surface at an outer surface 5 thereof, that is, at a tread surface 5 thereof. Reference character PC can represent the point of intersection of the tread surface 5 and the equator plane CL. The point of intersection PC can correspond to the equator of the tire 2.

The tread 4 can include a base portion 24 and a cap portion 26 located radially outward of the base portion 24. The base portion 24 can be formed, for instance, from a crosslinked rubber that has low heat generation properties and for which adhesiveness is taken into consideration. The cap portion 26 can be formed, for instance, from a crosslinked rubber for which wear resistance and grip performance are taken into consideration. The cap portion 26 can cover the entirety of the base portion 24.

In the tire 2, at least three circumferential grooves 28 can be formed on the tread 4. Accordingly, at least four land portions 30 can be formed in the tread 4. In the tire 2, at least four circumferential grooves 28 may be formed on the tread 4, and accordingly at least five land portions 30 may be formed in the tread 4.

In the tire 2 shown in FIG. 1, three circumferential grooves 28 are formed on the tread 4, and four land portions 30 are formed in the tread 4, though embodiments of the disclosed subject matter are not limited to this number of circumferential grooves 28 and land portions 30.

Each sidewall 6 can be connected to an end of the tread 4. The sidewall 6 can extend radially inward from the end of the tread 4. The sidewall 6 can be formed from a crosslinked rubber, for instance.

Each bead 8 can be located radially inward of the sidewall 6. The bead 8 can include a core 32 and an apex 34.

The core 32 can extend in the circumferential direction. The core 32 can include a wound wire made of steel, for instance.

The apex 34 can be located radially outward of the core 32. The apex 34 can extend radially outward from the core 32. The apex 34 can include an inner apex 34u and an outer apex 34 s. The inner apex 34u and the outer apex 34 s each can be formed from a crosslinked rubber, for instance. The outer apex 34 s can be more flexible than the inner apex 34u.

Each chafer 10 can be located axially outward of the bead 8. The chafer 10 can be located radially inward of the sidewall 6. The chafer 10 can come into contact with the rim R. The chafer 10 can be formed from a crosslinked rubber.

The carcass 12 can be located inward of the tread 4, each sidewall 6, and each chafer 10. The carcass 12 can extend on and between one bead 8 and the other bead 8. The carcass 12 can include at least one carcass ply 50. The carcass 12 of the tire 2 can be composed of one carcass ply 50, though embodiments of the present disclosure are not so limited.

As shown in FIG. 1, in the tire 2, the carcass ply 50 can be turned up around each core 32 from the inner side toward the outer side in the axial direction. The carcass ply 50 can have a body portion 50a, which can extend between one core 32 and the other core 32, and a pair of turned-up portions 50b which can be connected to the body portion 50a and turned up around the respective cores 32 from the inner side toward the outer side in the axial direction. In the tire 2, an end 54 of each turned-up portion 50b can be located located inward of an outer end 46 of the inner apex 34u in the radial direction.

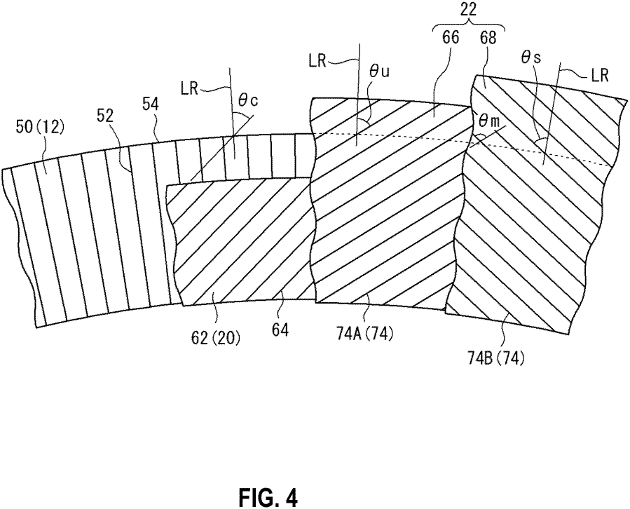

The carcass ply 50 can include a large number of carcass cords 52 (see FIG. 4) aligned with each other. The carcass cords 52 may be covered with a topping rubber. Each carcass cord 52 can intersect the equator plane CL. In the tire 2, an angle of each carcass cord 52 with respect to the equator plane CL can be not less than 70° and not greater than 90°. The carcass 12 can have a radial structure. In the tire 2, the material of the carcass cords 52 can be steel, for instance. A cord formed from an organic fiber may be used as each carcass cord 52.

FIG. 4 shows an arrangement state of the carcass cords 52 in a side surface portion of the tire 2. In FIG. 4, a solid line LR is a reference line extending in the radial direction. As shown in FIG. 4, in the side surface portion of the tire 2, the carcass cords 52 can extend in the radial direction.

In FIG. 1, reference character PC indicates a position at which the distance in the radial direction from the bead base line BBL to the inner surface of the carcass 12 is the maximum. In the tire 2, the position PC can be located on the equator plane CL.

The belt 14 can be located radially inward of the tread 4. The belt 14 can be located radially outward of the carcass 12 (body portion 50a).

In the tire 2, the belt 14 can include four belt plies 42. However, in the tire 2, the number of the belt plies 42 included in the belt 14 is not particularly limited. The configuration of the belt 14 can be determined as appropriate in consideration of the specifications of the tire 2.

Each belt ply 42 can include a large number of belt cords aligned with each other and a topping rubber. Each belt cord can be tilted relative to the equator plane CL. In the tire 2, in a belt ply 42A located on the innermost side in the radial direction, an angle of each belt cord with respect to the equator plane CL can be set in a range of not less than 40° and not greater than 60°, for instance. In a belt ply 42B, a belt ply 42C, and a belt ply 42D which can be located radially outward of the belt ply 42A, an angle of each belt cord with respect to the equator plane CL can be set in a range of not less than 15° and not greater than 25°, for instance.

In the tire 2, among the four belt plies 42, the belt ply 42B located between the belt ply 42A and the belt ply 42C can have the largest width in the axial direction. The belt ply 42D located on the outermost side in the radial direction can have the smallest width in the axial direction. In the tire 2, the material of the belt cords can be steel, for instance. A cord formed from an organic fiber may be used as each belt cord.

Each cushion layer 16 can be located between the belt 14 and the carcass 12 at a portion of the belt 14 at an end thereof, that is, at an end portion of the belt 14. The cushion layer 16 can be formed from a crosslinked rubber.

The inner liner 18 can be located inward of the carcass 12. The inner liner 18 can form an inner surface of the tire 2. The inner liner 18 can be formed from a crosslinked rubber that has a suitable air blocking property. The inner liner 18 can maintain the internal pressure of the tire 2.

The tread 4 can be formed from a crosslinked rubber, for instance. The tread 4 can come into contact with a road surface at the outer surface 5 thereof. The outer surface 5 of the tread 4 can be a tread surface.

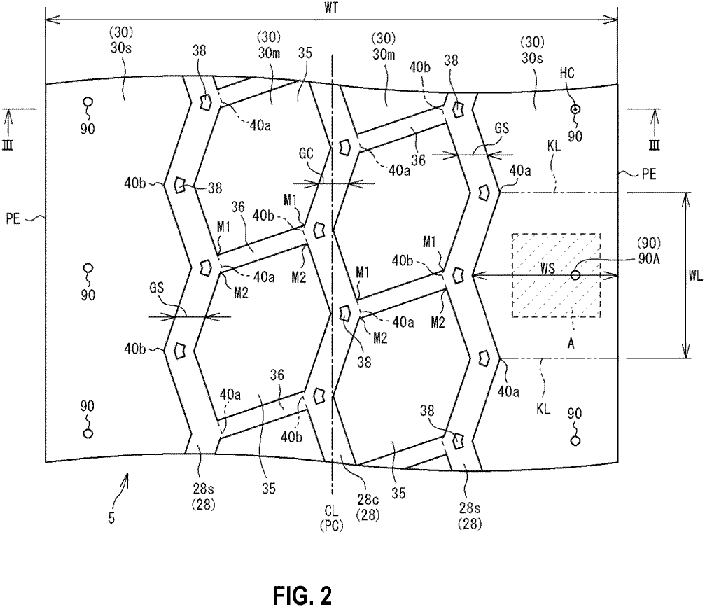

FIG. 2 shows a development of the tread surface 5 according to one or more embodiments of the present disclosure. In FIG. 2, the right-left direction is the axial direction of the tire 2, and the up-down direction is the circumferential direction of the tire 2. The direction perpendicular to the surface of the drawing sheet of FIG. 2 is the radial direction of the tire 2.

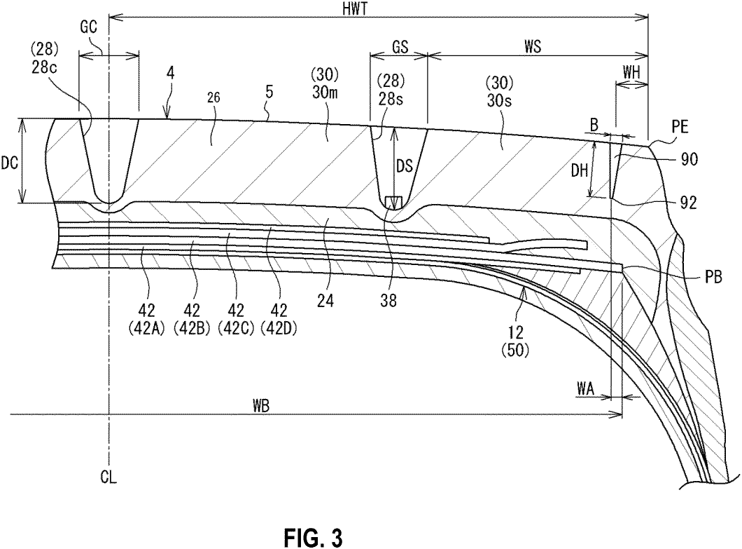

FIG. 3 shows a part of a tread portion in FIG. 1. In FIG. 3, the right-left direction is the axial direction of the tire 2, and the up-down direction is the radial direction of the tire 2. The direction perpendicular to the surface of the drawing sheet of FIG. 3 is the circumferential direction of the tire 2.

In the tire 2, at least three circumferential grooves 28 can be formed on the tread 4. Accordingly, at least four land portions 30 can be formed in the tread 4. Embodiments of the present disclosure, however, are not limited to three circumferential grooves 28 and four land portions 30.

In FIGS. 1 to 3, reference character PE indicates an end of the tread surface 5. In the tire 2, in a case where the ends PE of the tread surface 5 cannot be identified from the appearance, the outer ends in the axial direction of a ground-contact surface obtained when the standardized load is applied to the tire 2 in the standardized state and the tread 4 is brought into contact with a flat surface at a camber angle of 0° can be defined as the ends PE of the tread surface 5.

In FIG. 2, a double-headed arrow WT represents the width of the tread surface 5. The width WT of the tread surface 5 (hereinafter, referred to as tread surface width WT) is represented as the distance from one end PE of the tread surface 5 to the other end PE of the tread surface 5, measured along the tread surface 5. In FIG. 3, a double-headed arrow HWT represents half the length of the tread surface width WT. In addition, in FIG. 3, a double-headed arrow GC represents the width of a center circumferential groove 28c, and a double-headed arrow GS represents the width of a shoulder circumferential groove 28 s.

In the tire 2, the tread 4 can include at least four land portions 30 extending in the circumferential direction. These land portions 30 can extend in the circumferential direction. Further, these land portions 30 can be aligned in the axial direction. The tread 4 shown in FIG. 2 includes four land portions 30, though embodiments of the disclosed subject matter are not so limited, as noted above.

Among the four land portions 30, the land portion 30 located on each outermost side in the axial direction, that is, the land portion 30 including each end PE of the tread surface 5, can be regarded as a shoulder land portion 30s. The land portion 30 located inward of the shoulder land portion 30s in the axial direction can be regarded as a middle land portion 30 m.

The tire 2, according to one or more embodiments of the disclosed subject matter, can include two middle land portions 30 m, but the number of middle land portions located inward of each shoulder land portion 30s in the axial direction may be one or may be three or more.

In the tire 2, there can be a groove between one land portion 30 and another land portion 30 located adjacent to the one land portion 30. This groove can be a circumferential groove 28 continuously extending in the circumferential direction. The tread 4, according to one or more embodiments of the present disclosure, can include at least four land portions 30 extending in the circumferential direction, and there can be a circumferential groove 28 between one land portion 30 and a land portion 30 located adjacent to the one land portion 30.

On the tread 4 shown in FIG. 2, three circumferential grooves 28 can be formed, though embodiments of the disclosed subject matter are not so limited, as noted above.

Among these three circumferential grooves 28, the circumferential groove located on each outer side in the axial direction can be regarded as the shoulder circumferential groove 28 s. The circumferential groove located inward of the shoulder circumferential groove 28 s in the axial direction can be regarded as the center circumferential groove 28c. In the tire 2, the center circumferential groove 28c can be located on the equator plane CL, according to one or more embodiments of the present disclosure.

On the tread 4, one center circumferential groove 28c and a pair of shoulder circumferential grooves 28 s can be formed, though embodiments according to the present disclosure are not so limited.

For instance, another circumferential groove may exist between the center circumferential groove 28c and each shoulder circumferential groove 28 s. In this case, the circumferential groove located between the center circumferential groove 28c and each shoulder circumferential groove 28 s can also be regarded as a middle circumferential groove.

Moreover, in the tire 2, as a circumferential groove, a circumferential groove located on the equator plane CL may not necessarily be included, according to one or more embodiments of the present disclosure.

In the tire 2, at least one land portion 30 out of the land portions 30 included in the tread 4 can include a relatively large number of blocks 35 aligned in the circumferential direction.

As shown in FIG. 2, in the tire 2, each of the two middle land portions 30 m included in the tread 4 can include a relatively large number of blocks 35.

All the land portions 30 may include the above relatively large number of blocks, or only each shoulder land portion 30s may include the above relatively large number of blocks.

Furthermore, in a tire including a plurality of middle land portions, only a part of the middle land portions may include a relatively large number of blocks 35, or a part of the middle land portions and each shoulder land portion may include a relatively large number of blocks 35.

The land portion 30 including a relatively large number of blocks 35 can be determined as appropriate in consideration of the specifications of the tire 2, etc.

In the tire 2, from the viewpoint of ensuring the flexibility of the tread 4, the land portions 30 may have sipes.

The sipes provided on the tread 4 can contribute to ensuring the flexibility of the tread 4.

In the tire 2, there can be a groove between one block 35 and another block 35 located adjacent to the one block 35. This groove can be regarded as a lateral groove 36. As shown in FIG. 2, a relatively large number of lateral grooves 36 can be formed on the tread 4. Each lateral groove 36 can be connected to the circumferential grooves 28.

In the tire 2, according to one or more embodiments of the present disclosure, the lateral grooves 36 can be formed on the middle land portions 30 m.

At the position at which each lateral groove 36 and each circumferential groove 28 are connected to each other, an opening of the lateral groove 36 can be provided in a wall of the circumferential groove 28. In FIG. 2, reference character M1 indicates the boundary between one wall of the lateral groove 36 and the wall of the circumferential groove 28. Reference character M2 indicates the boundary between another wall of the lateral groove 36 and the wall of the circumferential groove 28. The portion between the boundary M1 and the boundary M2 corresponds to the opening, of the lateral groove 36, which can be provided in the wall of the circumferential groove 28.

In the tire 2, lateral grooves 36 may also be provided on the shoulder land portions 30s. In this case, on the tread 4, lateral grooves can be formed so as to extend between portions at the ends PE of the tread surface 5, that is, end portions of the tread 4, and the shoulder circumferential grooves 28 s.

In the tire 2 according to one or more embodiments of the present disclosure, the width of each lateral groove 36 can be at or approximately not less than 30% and not greater than 90% of the width of the circumferential groove 28. In addition, the depth of each lateral groove 36 can be not less than 3 mm and not greater than 20 mm.

As shown in FIGS. 1 to 3, in the tire 2, the circumferential groove 28 can include a large relatively number of projections 38. These projections 38 can be arranged along the circumferential groove 28 so as to be spaced apart from each other. As shown in FIG. 1 and FIG. 3, for instance, each projection 38 can project outward from the bottom surface of the circumferential groove 28. According to one or more embodiments, each projection 38 can be located at the center in the width direction of the groove 28.

As shown in FIG. 2, each projection 38 can be located at the position at which the lateral groove 36 and the circumferential groove 28 are connected to each other.

In the tire 2, the projections 38 can be provided in all the circumferential grooves 28 formed on the tread 4. According to one or more embodiments, the projections 38 may be provided only in the center circumferential groove 28c, or may be provided only in the shoulder circumferential grooves 28 s. Optionally, no projection 38 may be provided in each lateral groove 36 of the tire 2.

In the tire 2, the projections 38 provided in the circumferential grooves 28 can serve as obstacles for stones that are about to enter or have entered (at least partially) the circumferential grooves 28.

As shown in FIG. 2, for instance, each circumferential groove 28 of the tire 2 can be a zigzag circumferential groove extending in a zigzag manner. In the tire 2, the center circumferential groove 28c can continuously extend in the circumferential direction in a zigzag manner. Each shoulder circumferential groove 28 s can continuously extend in the circumferential direction in a zigzag manner.

Each circumferential groove 28 can have zigzag peaks 40a projecting on one side and zigzag peaks 40b projecting on the other side in the axial direction. In the circumferential groove 28, the zigzag peaks 40a and the zigzag peaks 40b can be alternately arranged in the circumferential direction. The circumferential groove 28 can continuously extend in the circumferential direction while bending in a zigzag manner.

Since the circumferential groove 28 can continuously extend in the circumferential direction, on a wet road surface, the circumferential groove 28 can smoothly guide a water film existing between the tread 4 and the road surface, in the circumferential direction. Further, since the circumferential groove 28 can bend in a zigzag manner, the circumferential groove 28 can serve as an edge component in the axial direction, and can contribute to improvement of traction performance on a wet road surface. From this viewpoint, in the tire 2 according to one or more embodiments of the present disclosure, the circumferential groove 28 can be regarded as a zigzag circumferential groove extending in a zigzag manner.

As shown in FIG. 2, each lateral groove 36 can extend between the zigzag peak 40a of the center circumferential groove 28c and the zigzag peak 40b of the shoulder circumferential groove 28 s or between the zigzag peak 40b of the center circumferential groove 28c and the zigzag peak 40a of the shoulder circumferential groove 28 s.

In the tire 2 according to one or more embodiments of the present disclosure, at the zigzag peak 40a or the zigzag peak 40b of each circumferential groove 28, the lateral groove 36 can be connected to this circumferential groove 28. The zigzag peaks 40a and 40b of the circumferential groove 28 can be formed at the edge on the outer side of bending of the zigzag circumferential groove 28. On the outer side of bending of the zigzag circumferential groove 28, the lateral groove 36 can be connected to the zigzag circumferential groove 28.

In the tire 2, each lateral groove 36 can be provided at a portion at which the distance between the adjacent circumferential grooves 28 is relatively short. The lateral groove 36 can be formed such that the length thereof is shorter (e.g., than the portion at which the distance between the adjacent circumferential grooves 28 is relatively short).

In the tire 2 according to one or more embodiments of the present disclosure, the longitudinal direction of each lateral groove 36 can be tilted relative to the axial direction of the tire 2. The longitudinal direction of each lateral groove 36 may coincide with the axial direction of the tire 2.

In the tire 2 according to one or more embodiments of the present disclosure, from the viewpoint of contribution to drainage performance and traction performance, the width GC of the center circumferential groove 28c can be at or approximately not less than 2% and not greater than 10% of the tread surface width WT, for instance. A depth DC of the center circumferential groove 28c can be not less than 13 mm and not greater than 25 mm, for instance.

In the tire 2 according to one or more embodiments of the present disclosure, from the viewpoint of contribution to drainage performance and traction performance, the width GS of each shoulder circumferential groove 28 s can be at or approximately not less than 2% and not greater than 10% of the tread surface width WT, for instance. The depth DS of each shoulder circumferential groove 28 s can be not less than 13 mm and not greater than 25 mm, for instance.

In the tire 2, holes 90 can be provided in the shoulder land portions 30s. As shown in FIGS. 1 to 3, each hole 90 can extend from the outer surface, of the shoulder land portion 30s, which can form a part of the tread surface 5, toward the belt 14. The hole 90 can overlap the belt 14 in the radial direction. A bottom 92 of the hole 90 can be located radially outward of the belt 14. In FIG. 2, reference character HC indicates the center of the opening of the hole 90 provided in the shoulder land portion 30s. In FIG. 2, a line III-III is a straight line passing through the center HC of the hole 90 and extending in the axial direction.

As described above, the tread 4 of the tire 2 can include the base portion 24 and the cap portion 26. The boundary between the base portion 24 and the cap portion 26 can be included in the tread 4. As shown in FIG. 3, in the tire 2, according to one or more embodiments of the present disclosure, in the shoulder land portion 30s, the bottom 92 of each hole 90 can be located radially outward of this boundary.

In FIG. 2, a double-headed arrow WS represents the maximum width in the axial direction of the shoulder land portion 30s. Since each shoulder circumferential groove 28 s can be a zigzag circumferential groove, the dimension in the axial direction of the shoulder land portion 30s can change along the shoulder circumferential groove 28 s. In the shoulder land portion 30s, a portion at which the distance between the outer edge in the axial direction of the shoulder circumferential groove 28 s and the end PE of the tread surface 5 has a maximum value can be a portion having the maximum width in the axial direction.

In FIG. 2, a double-headed arrow WL represents the separation distance along the tread surface of the tire 2 between adjacent portions having the minimum width in the axial direction of the shoulder land portion 30s.

In the tire 2 having the zigzag circumferential grooves 28, portions having the minimum width in the axial direction of the shoulder land portion 30s can exist such that a portion having the maximum width in the axial direction of the shoulder land portion 30s is located therebetween. In the shoulder land portion 30s, a portion at which the distance between the outer edge in the axial direction of the shoulder circumferential groove 28 s and the end PE of the tread surface 5 has a minimum value can be a portion having the minimum width in the axial direction. In FIG. 2, a portion indicated by a virtual line KL is an example of a portion having the minimum width in the axial direction of the shoulder land portion 30s.

According to one or more embodiments of the present disclosure, the formed position of each hole 90 in the tire 2 can be a position overlapping a portion having the maximum width in the axial direction of the shoulder land portion 30s as shown in FIG. 2.

In addition, the formed position of the hole 90 can be a position relatively close to a portion having the maximum width in the axial direction of the shoulder land portion 30s. Specifically, the formed position of the hole 90 can be a position at which the separation distance along the circumferential direction from the portion having the maximum width in the axial direction of the shoulder land portion 30s is not greater than 25% of the separation distance WL along the tread surface of the tire 2 between the adjacent portions having the minimum width in the axial direction of the shoulder land portion 30s, for instance.

If the formed position of the hole 90 is farther away from the portion having the maximum width in the axial direction, the hole 90 can be provided in a portion, of the shoulder land portion 30s, in which the width in the axial direction is relatively small and the stiffness is relatively low. In this case, the stiffness difference can be increased in the shoulder land portion 30s, so that uneven wear starting from the hole 90 may be likely to occur.

Furthermore, as described later, a distance WH from the hole 90 to the outer end PE of the shoulder land portion 30s can be not less than 0.12 times and not greater than 0.88 times the maximum width WS in the axial direction of the shoulder land portion 30s, for instance.

When a formed position of one hole 90A included in the tire 2 is shown in consideration of these features, a region A shown in FIG. 2 can be representative of an example of the formed position of the hole 90A.

FIG. 3 shows a part of the tread portion of the tire 2 in FIG. 1.

In FIG. 3, a double-headed arrow WH represents the distance in the axial direction from the center HC of an opening 90a of the hole 90 to the end PE of the tread surface 5.

In the tire 2, according to one or more embodiments of the present disclosure, the distance WH from the hole 90 to the outer end PE of the shoulder land portion 30s can be not less than 0.12 times and not greater than 0.88 times the maximum width WS in the axial direction of the shoulder land portion 30s, as an example.

When the formed position of the hole 90 is set to a position away from the outer end PE of the shoulder land portion 30s by a certain distance, the stiffness of an outer region in the axial direction of the shoulder land portion 30s with respect to the hole 90 can be ensured, for instance, so that the shape of the hole 90 is less likely to be changed in the tire width direction even when a lateral force is applied to a projecting object trapped in the hole 90.

On the other hand, if WH/WS is less than 0.12, the stiffness of the outer region in the axial direction with respect to the hole 90 is decreased, so that rib tear is likely to occur when a lateral force is applied in a state where a stone or the like is trapped in the hole 90. If WH/WS exceeds 0.88, the object of shortening the vulcanization time during production of the tire 2 is less likely to be achieved.

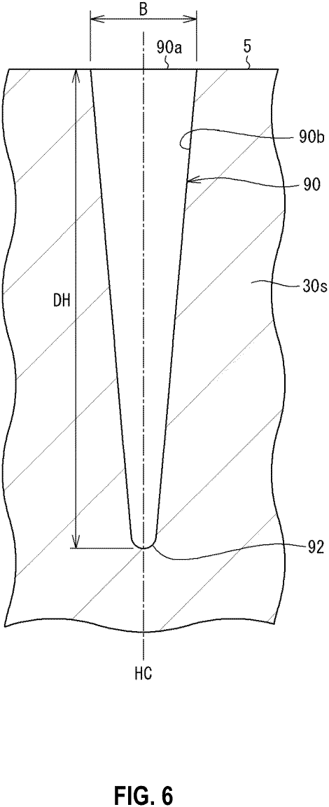

FIG. 6 shows a part of the cross-section of the tire 2 shown in FIG. 3. FIG. 6 shows the hole 90 provided in the shoulder land portion 30s. In FIG. 6, a double-headed arrow B represents the width of the opening 90a of the hole 90 (hereinafter, also referred to as opening width B).

The shape of the opening 90a of the hole 90 can be a circle, as an example, such as shown in FIG. 2. The shape of the opening 90a of the hole 90 is not limited, and may be a shape having corners such as a quadrangle, but particularly may be a shape having no corners such as a circle or an ellipse. This is because it may be relatively easy to pull out a projection 94 from the tire 2 in the production of the tire 2 and the obtained tire 2 can have good crack resistance. In the case where the shape of the opening 90a of the hole 90 is an ellipse, a central axis HC of this hole 90 can pass through the point of intersection of the major and minor axes of the ellipse.

The area (opening area) of the opening 90a of the hole 90 can be not less than 2 mm² and not greater than 20 mm², for instance.

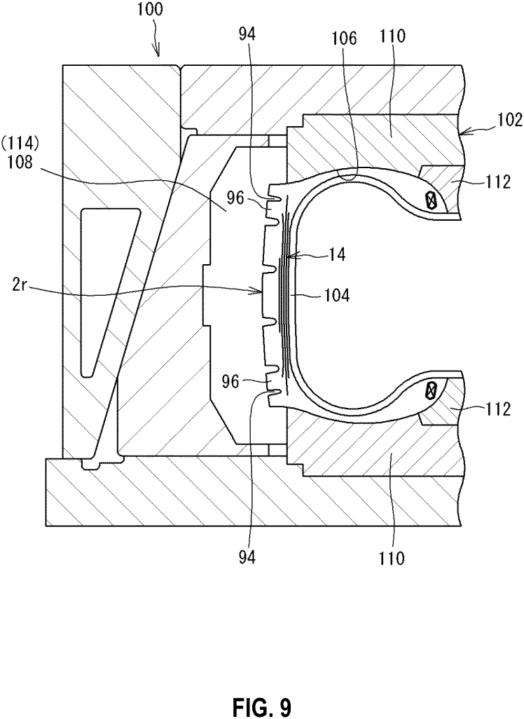

If the above opening area is less than 2 mm², the surface area of the projection 94 (see FIG. 9) which is inserted into an unvulcanized shoulder land portion during production of the tire 2 may be relatively small, so that an effect of transmitting heat to the interior of the tire 2 becomes insufficient. In addition, the strength of the projection 94 may become low, so that bending or breakage of the projection 94 is likely to occur. On the other hand, if the above opening area exceeds 20 mm², a stone or a projecting object may be more likely to be caught in the hole 90, which may cause relatively large cracks.

In the tire 2, one or more holes 90 can be provided in one shoulder land portion 30s. Here, a ratio of the sum of the opening areas of all the holes 90 provided in one shoulder land portion 30s to the area of the tread surface of the one shoulder land portion 30s (including a portion in which the opening 90a of each hole 90 is formed) can be not less than 0.15% and not greater than 5%, for instance. If the sum of the opening areas of the holes 90 is greater than 5% of the area of the tread surface of the shoulder land portion 30s, the probability of trapping a projecting object such as a stone in the hole 90 may be increased, so that the risk of rib tear occurring when a lateral force is applied is increased. On the other hand, if the sum of the opening areas of the holes 90 is less than 0.15% of the area of the tread surface of the shoulder land portion 30s, the effect of shortening the vulcanization time, which is one object of the present disclosure, can be reduced.

A cross-sectional shape of the hole 90 can be a shape in which the dimension parallel to the opening width B gradually decreases from the opening 90a of the hole 90 toward the bottom 92 as shown in FIG. 6. As an example, the shape of the hole 90 can be a inverted (e.g., inverted or substantially inverted) conical shape, such as shown in FIG. 6. In FIG. 6, reference character HC indicates the central axis of the hole 90. In FIG. 6, a double-headed arrow DH represents the depth of the hole 90.

The opening width B of the hole 90 and the depth DH of the hole 90 each can be specified in the cross-section shown in FIG. 6, that is, a cross-section of the tire 2 along a plane including the rotation axis of the tire 2 and the central axis HC of the hole 90.

In the case where the hole 90 has such a shape, a projecting object such as a stone may be less likely to enter the interior of the hole 90, and even if entering (e.g., partially) may be less likely to be held in the hole 90, so that stone trapping or the like which can be prevented or less likely to be a starting point of rib tear as occurring.

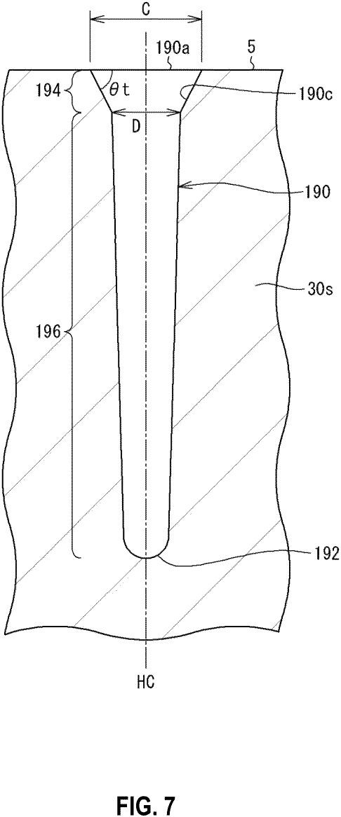

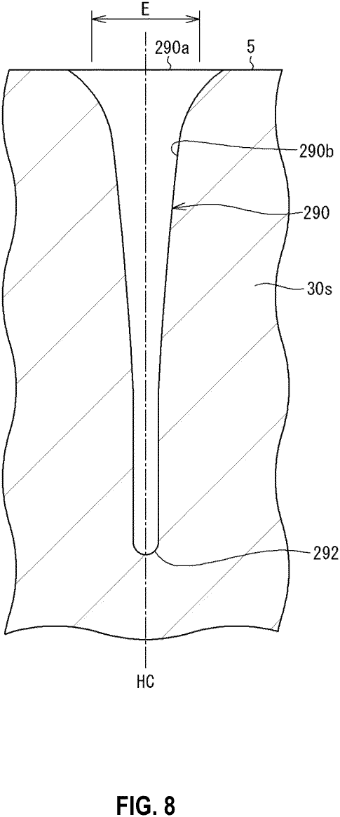

The cross-sectional shape of the hole 90 is not limited to the shape shown in FIG. 6. FIGS. 7 and 8 are each a cross-sectional view showing another shape of the hole that can be provided in the shoulder land portion 30s of the tire 2 according to one or more embodiments of the present disclosure.

A hole 190 in the tire shown in FIG. 7 can include a tapered portion 194 which can be provided on an opening 190a side of the hole 190 and in which a wall surface can be relatively greatly tilted, and a hole body portion 196 which can be provided on a bottom 192 side of the hole 190 with respect to the tapered portion 194. The shape of the opening 190a of the hole 190 can be a circle, as an example.

In the tire 2 in which the hole 190 is provided, according to one or more embodiments of the present disclosure, the tapered portion 194 can suppress movement of the tread surface 5 surrounding the opening 190a. By providing the tapered portion 194, occurrence of uneven wear can be further suppressed.

Moreover, the tire 2 including the hole 190 having the tapered portion 194 can also have excellent demoldability after vulcanization.

In FIG. 7, an angle θt is an angle of a wall surface 190c of the tapered portion 194 with respect to a virtual tread surface obtained at the tapered portion 194 of the hole 190 on the assumption that the hole 190 is not provided (hereinafter, sometimes referred to as tilt angle of the wall surface 190c in the tapered portion 194).

In the tire 2, according to one or more embodiments of the present disclosure, the tilt angle θt of the wall surface 190c in the tapered portion 194 can be not greater than 80°, for instance. Accordingly, movement of the tread surface 5 surrounding the opening 190a can be effectively suppressed. In the tire 2, occurrence of uneven wear can be effectively suppressed. From this viewpoint, the angle θt can be not greater than 70°, for instance, not greater than 60°. From the same viewpoint, the angle θt can be not less than 20°, for instance, not less than 30°, such as not less than 40°.

In the hole 190 having the tapered portion 194, the ratio of a diameter D of a boundary portion between the tapered portion 194 and the hole body portion 196 to a diameter C of the opening 190a can be not less than 0.4 and not greater than 0.8, for instance.

A hole 290 in the tire shown in FIG. 8 can have a shape similar to or the same as that of the hole 90 having an inverted (inverted or substantially inverted) conical shape shown in FIG. 6, but the shape of a wall surface 290b can be different therefrom. In the cross-sectional view of the hole 290 shown in FIG. 8, a line indicating the wall surface 290b is a curved line that can be convex on the hole side. The hole 290 can have a shape drawn by rotating the cross-sectional shape shown in FIG. 8 about the central axis HC. In other words, the shape of the hole 290 can be a shape in which the wall surface 290b from an opening 290a to a bottom 292 of the hole 290 has a curved surface that is warped in a direction in which the volume of the hole 290 is reduced.

In the tire 2 in which such a hole 290 is provided, the dimension parallel to an opening width E can gradually decrease from the opening 290a toward the bottom 292 of the hole 290, for instance, so that a projecting object such as a stone is prevented from or less likely to enter the interior of the hole 290, and, if does enter (e.g., partially), can be less likely to be held in the hole 290. Therefore, stone trapping or the like, which can be a starting point of rib tear, can be less likely to occur. Furthermore, the shape of the wall surface 290b of the hole 290 can be a shape suitable for alleviating strain, for instance, so in the event that stone trapping does happen to occur, the stone trapping is less likely to become a starting point of a crack.

Referring back to FIG. 3, a double-headed arrow DC represents the depth of the center circumferential groove 28c. A double-headed arrow DS represents the depth of the shoulder circumferential groove 28 s. A double-headed arrow DH represents the depth of the hole 90.

In tire 2 according to one or more embodiments of the present disclosure, the depth DH of the hole 90 can be not less than ⅓ times and not greater than 1 times the depth DS of the shoulder circumferential groove 28 s, for instance.

If the depth DH of the hole 90 is less than ⅓ times the depth DS of the shoulder circumferential groove 28 s, the object of shortening the vulcanization time during production of the tire 2 may be less likely to be achieved. On the other hand, if the depth DH of the hole 90 is larger than the depth DS of the shoulder circumferential groove 28 s, rib tear may be likely to occur in the shoulder land portion 30s of the tire 2. In addition, a projection (see, e.g., 94 in FIG. 9) which can be inserted into a hole during production of the tire 2, may be broken or bent.

In FIG. 3, an arrow WB represents the maximum width in the axial direction of the belt 14. A double-headed arrow WA represents the distance in the axial direction between an outer end PB in the axial direction of the belt 14 and the bottom 92 of the hole 90.

In the tire 2 according to one or more embodiments of the present disclosure, the distance WA in the axial direction can be not less than 4% of the maximum width WB in the axial direction of the belt 14, for instance.

If the distance WA is less than 4% of the distance WB, the bottom 92 of the hole 90 may be undesirably close to the outer end PB of the belt 14, for instance, so that the bottom 92 of the hole 90 or the outer end PB of the belt 14 may become a starting point of a crack. Furthermore, if the bottom 92 of the hole 90 is located axially outward of the outer end PB of the belt 14, the effect of transmitting heat to the interior of the shoulder land portion 30s may be reduced, and the stiffness of the outer region in the axial direction of the shoulder land portion 30s with respect to the hole 90 may also be decreased, for instance, so that the possibility of rib tear occurring when a lateral force is applied in a state where a stone is trapped in the hole 90 may be increased.

In the tire 2, the distance WA in the axial direction can be not greater than 16% of the maximum width WB in the axial direction of the belt 14, for instance.

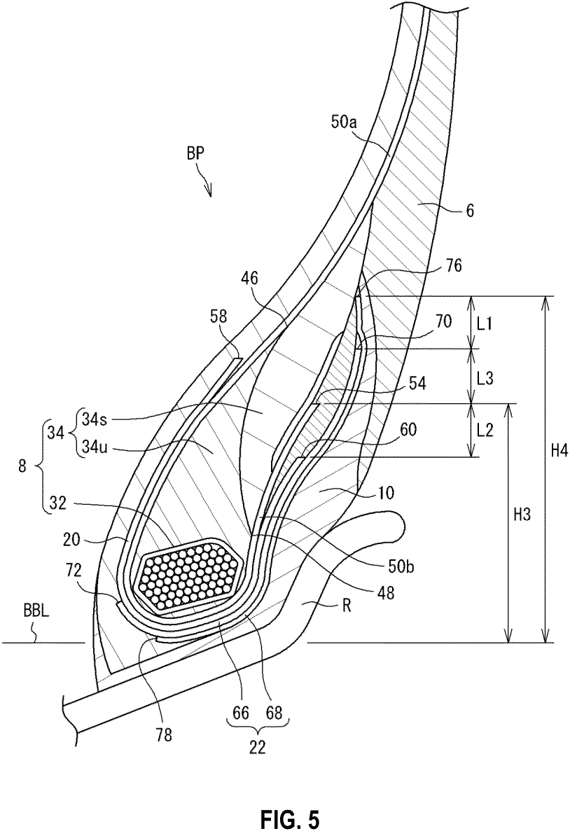

FIG. 5 shows a bead portion BP in FIG. 1. In FIG. 5, the right-left direction is the axial direction of the tire 2, and the up-down direction is the radial direction of the tire 2. The direction perpendicular to the surface of the drawing sheet of FIG. 5 is the circumferential direction of the tire 2.

In FIG. 5, a double-headed arrow H3 represents the distance in the radial direction from the bead base line BBL to the end 54 of the turned-up portion 50b of the carcass ply 50. A double-headed arrow H4 represents the distance in the radial direction from the bead base line BBL to an outer end 76 of an outer fiber reinforcing layer 68.

Each steel reinforcing layer 20 can be located in the bead portion BP.

The steel reinforcing layer 20 can be turned up around the core 32 from the inner side toward the outer side in the axial direction along the carcass ply 50. In the tire 2 according to one or more embodiments of the present disclosure, at least a part of the steel reinforcing layer 20 can be in contact with the carcass ply 50.

An inner end 58 of the steel reinforcing layer 20 can be located inward of the body portion 50a in the axial direction. The inner end 58 can be located between the outer end 46 of the inner apex 34u and the core 32 in the radial direction. An outer end 60 of the steel reinforcing layer 20 can be located outward of the turned-up portion 50b in the axial direction. The outer end 60 can be located between the end 54 of the turned-up portion 50b and an inner end 48 of the outer apex 34 s in the radial direction. The inner end 58 of the steel reinforcing layer 20 can be located outward of the outer end 60 of the steel reinforcing layer 20 in the radial direction.

The steel reinforcing layer 20 can include at least one steel ply 62 (e.g., one or more). In the tire 2, the steel reinforcing layer 20 can be composed of or consist of one steel ply 62. The steel ply 62 can include a relatively large number of steel cords 64, for instance, aligned with each other. These steel cords 64 can be covered with a topping rubber.

FIG. 4 shows an arrangement state of the steel cords 64 included in the steel ply 62 forming the steel reinforcing layer 20 according to one or more embodiments of the present disclosure. As shown in FIG. 4, in the tire 2, in the steel reinforcing layer 20, the steel cords 64 can be tilted relative to the carcass cords 52.

In FIG. 4, reference character θc represents an intersection angle between the steel cord 64 and the carcass cord 52. In the tire 2, the intersection angle θc between the steel cord 64 and the carcass cord 52 can be not less than 30° and not greater than 70°, for instance. Here, the intersection angle θc between the steel cord 64 and the carcass cord 52 can be an angle formed therebetween at an outer end 54 of the carcass cord 52.

The number of the steel cords 64 in the steel ply 62 can be not less than 20 and not greater than 40 per 50 mm width of the steel ply 62, for instance.

In the tire 2, the steel reinforcing layer 20 can contribute to improvement of the bending stiffness of the bead portion BP. In the tire 2, relatively great bending deformation of the bead portion BP toward the outer side in the axial direction with the core 32 as a fulcrum can be effectively suppressed.

Each fiber reinforcing layer 22 can be located in the bead portion BP.

In the tire 2, at least a part of the fiber reinforcing layer 22 can extend in the radial direction on the axially outer side in the steel reinforcing layer 20. The fiber reinforcing layer 22 can include a large number of fiber cords 74 aligned with each other. These fiber cords 74 can be formed from a nylon fiber, as an example.

The fiber reinforcing layer 22 can include at least an inner fiber reinforcing layer 66 and the outer fiber reinforcing layer 68 (described later). In the tire 2, the fiber reinforcing layer 22 can be composed of or consist of the inner fiber reinforcing layer 66 and the outer fiber reinforcing layer 68, that is, two plies. The fiber reinforcing layer 22 may be composed of three or more plies, for instance.

The inner fiber reinforcing layer 66 can be in contact with the steel reinforcing layer 20. The inner fiber reinforcing layer 66 can cover the outer end 60 of the steel reinforcing layer 20 from the outer side in the axial direction. An outer end 70 of the inner fiber reinforcing layer 66 can be located outward of the outer end 60 of the steel reinforcing layer 20 in the radial direction. An inner end 72 of the inner fiber reinforcing layer 66 can be located inward of the core 32 in the axial direction.

In the tire 2, the outer end 70 of the inner fiber reinforcing layer 66 can be located outward of the end 54 of the turned-up portion 50b of the carcass ply 50 in the radial direction.

As shown in FIG. 4, the inner fiber reinforcing layer 66 can include a relatively large number of fiber cords (also referred to as inner fiber cords) 74A, for instance, aligned with each other. In the tire 2, the number of the inner fiber cords 74A in the inner fiber reinforcing layer 66 can be not less than 20 and not greater than 70 per 50 mm width of the inner fiber reinforcing layer 66, for instance. In this case, the holding force of the inner fiber cords 74A can sufficiently act on the carcass 12, for instance, so that the stiffness in the radial direction of the tire 2 at the sidewall 6 can be increased.

On the other hand, if the number of the inner fiber cords 74A is less than 20 per 50 mm, the holding force of the inner fiber cord 74A on the carcass 12 may be decreased, for instance, so that it may be difficult to suppress falling-down of an end portion of the carcass 12. In addition, if the number of the inner fiber cords 74A exceeds 70 per 50 mm, for instance, strain may be concentrated on the outer ends of the inner fiber cords 74A (outer end portion of the inner fiber reinforcing layer 66), and the outer ends of the inner fiber cords 74A may become a starting point of damage.

Thus, according to one or more embodiments of the present disclosure, the number of the inner fiber cords 74A in the inner fiber reinforcing layer 66 can be not less than 30 and not greater than 50 per 50 mm width of the inner fiber reinforcing layer 66, as an example range.

The outer fiber reinforcing layer 68 can be in contact with the inner fiber reinforcing layer 66. The outer fiber reinforcing layer 68 can cover the outer end 70 of the inner fiber reinforcing layer 66 from the outer side in the axial direction. The outer end 76 of the outer fiber reinforcing layer 68 can be located outward of the outer end 70 of the inner fiber reinforcing layer 66 in the radial direction. An inner end 78 of the outer fiber reinforcing layer 68 can be located outward of the inner end 72 of the inner fiber reinforcing layer 66 in the axial direction, and can be located inward of the core 32 in the radial direction.

In this case, the distance H4 in the radial direction from the bead base line BBL to the outer end 76 of the outer fiber reinforcing layer 68 can be not less than 1.4 times and not greater than 1.8 times the distance H3 in the radial direction from the bead base line BBL to the end 54 of the turned-up portion 50b of the carcass ply 50, for instance. In this case, falling-down of the end portion of the carcass 12 can be appropriately suppressed.

On the other hand, if the distance H4 is less than 1.4 times the distance H3, falling-down of the end portion of the carcass 12 may not be able to be sufficiently suppressed by the outer fiber reinforcing layer 68, at least in some cases. In addition, if the distance H4 exceeds 1.8 times the distance H3, the stiffness in the radial direction of the sidewall 6 of the tire 2 may be excessively increased by the outer fiber reinforcing layer 68, for instance, so that ride comfort may be deteriorated or separation at the bead portion BP may be more likely to occur.

In the tire 2, the outer end 76 of the outer fiber reinforcing layer 68 can be located so as to be separated radially outward from the outer end 70 of the inner fiber reinforcing layer 66 by a distance L1. Accordingly, concentration of strain on the outer end 70 of the inner fiber reinforcing layer 66 can be suppressed, for instance, so that occurrence of separation between the inner fiber reinforcing layer 66 and the outer fiber reinforcing layer 68 can be suppressed.

From this viewpoint, in the tire 2, the distance in the radial direction (L1 in FIG. 5) between the outer end 70 of the inner fiber reinforcing layer 66 and the outer end 76 of the outer fiber reinforcing layer 68 can be not less than 10 mm and not greater than 15 mm, for instance.

If the distance L1 in the radial direction is less than 10 mm, the end points of the fiber cords (nylon fibers) may be excessively close to each other, for instance, so that separation between the inner fiber reinforcing layer 66 and the outer fiber reinforcing layer 68 may be likely to occur. On the other hand, if the distance L1 in the radial direction exceeds 15 mm, the outer end 76 of the outer fiber reinforcing layer 68 may easily move, and in this case as well, separation between the inner fiber reinforcing layer 66 and the outer fiber reinforcing layer 68 may be likely to occur.

As shown in FIG. 4, the outer fiber reinforcing layer 68 can include a relatively large number of fiber cords (also referred to as outer fiber cords) 74B, for instance, aligned with each other. In the tire 2, the number of the outer fiber cords 74B in the outer fiber reinforcing layer 68 can be not less than 20 and not greater than 70 per 50 mm width of the outer fiber reinforcing layer 68, for instance. In this case, the holding force of the outer fiber cords 74B can sufficiently act on the carcass 12, for instance, so that the stiffness in the radial direction of the tire 2 at the sidewall 6 can be increased.

On the other hand, if the number of the outer fiber cords 74B is less than 20 per 50 mm, the holding force of the outer fiber cords 74B on the carcass 12 may be decreased, for instance, so that it may be difficult to suppress falling-down of the end portion of the carcass 12. In addition, if the number of the outer fiber cords 74B exceeds 70 per 50 mm, strain may be concentrated on the outer ends of the outer fiber cords 74B (outer end portion of the outer fiber reinforcing layer 68), and the outer ends of the outer fiber cords 74B may become a starting point of damage.

The number of the outer fiber cords 74B in the outer fiber reinforcing layer 68 can be not less than 30 and not greater than 50 per 50 mm width of the outer fiber reinforcing layer 68, as an example range.

In the tire 2, the total fineness of the fiber cords 74 formed from a nylon fiber can be not less than 940 dtex and not greater than 1400 dtex, for instance.

If the total fineness of the fiber cords 74 is less than 940 dtex, the fiber cords 74 may be regarded as relatively thin, for instance, so that there can be a possibility that an effect of distributing strain in the bead portion BP cannot be sufficiently obtained. On the other hand, if the total fineness of the fiber cords 74 exceeds 1400 dtex, the fiber cords 74 may be regarded as relatively thick, for instance, so that there is a possibility that a portion around the outer end 76 of the outer fiber reinforcing layer 68 may become a starting point of damage.

Each fiber cord 74 may be a cord obtained by twisting one yarn, or may be a cord obtained by twisting a plurality of yarns.

In the tire 2, from the viewpoint of reducing the production cost by sharing components, the inner fiber reinforcing layer 66 and the outer fiber reinforcing layer 68 can have the same length, for example, in the cross-section of the tire 2 shown in FIG. 5 as for a length measured along the shape of the cross-section.

In the tire 2 according to one or more embodiments of the present disclosure, the fiber reinforcing layer 22 can contribute to the stiffness of the bead portion BP. In particular, since the fiber reinforcing layer 22 can include the fiber cords 74 formed from a nylon fiber, the bead portion BP may not become excessively hard and can have suitable flexibility (e.g., moderate flexibility). The fiber reinforcing layer 22 may not only improve the durability of the bead portion BP, but may also suppress falling of the bead portion BP outward in the axial direction when filled with air. In the tire 2, since falling of the bead portion BP outward in the axial direction can be suppressed, movement of an end portion (shoulder portion) of the tread 4 toward the radially inner side can also be suppressed.

As described above, each of the inner fiber reinforcing layer 66 and the outer fiber reinforcing layer 68 which form the fiber reinforcing layer 22 of the tire 2 can include a relatively large number of fiber cords 74, for instance, aligned with each other. As shown in FIG. 4, in the inner fiber reinforcing layer 66, the fiber cords 74 can be tilted relative to the radial direction. In the outer fiber reinforcing layer 68, the fiber cords 74 can be tilted relative to the radial direction. The tilt direction of the fiber cords 74 in the outer fiber reinforcing layer 68 can be opposite to the tilt direction of the fiber cords 74 in the inner fiber reinforcing layer 66. The fiber reinforcing layer 22 including such an inner fiber reinforcing layer 66 and such an outer fiber reinforcing layer 68 can effectively suppress falling of the bead portion BP outward in the axial direction when filled with air. From this viewpoint, in the tire 2, the fiber cords 74 in the inner fiber reinforcing layer 66 can be tilted relative to the radial direction, the fiber cords 74 in the outer fiber reinforcing layer 68 can be tilted relative to the radial direction, and the tilt direction of the fiber cords 74 in the inner fiber reinforcing layer 66 can be opposite to the tilt direction of the fiber cords 74 in the outer fiber reinforcing layer 68.

In FIG. 4, reference character θu represents an intersection angle between the inner fiber cord 74A in the inner fiber reinforcing layer 66 and the carcass cord 52. Reference character θs represents an intersection angle between the outer fiber cord 74B in the outer fiber reinforcing layer 68 and the carcass cord 52. Here, the intersection angle between the fiber cord 74 and the carcass cord 52 is an angle formed therebetween at the outer end of the carcass cord 52.

In the tire 2 according to one or more embodiments of the present disclosure, the intersection angle θu between the inner fiber cord 74A and the carcass cord 52 can be not less than 40 degrees and not greater than 80 degrees, for instance, the outer fiber cords 74B can be tilted in a direction opposite to that of the inner fiber cords 74A, and the intersection angle θs between the outer fiber cord 74B and the carcass cord 52 can be not less than 40 degrees and not greater than 80 degrees, for instance.

In this case, the tensile force of the carcass cords 52 can be effectively reduced, for instance, so that falling-down of the end portion of the carcass 12 can be suppressed.

In the tire 2, the intersection angle θu and the intersection angle θs may be equal to or different from each other. From the viewpoint of reducing the production cost by sharing components, for instance, the intersection angle θu and the intersection angle θs can be equal to each other.

In one or more embodiments of the present disclosure, when the absolute value of the difference between the intersection angle θu and the intersection angle θs is not greater than 2°, it can be determined that the intersection angle θu between the inner fiber cord 74A and the carcass cord 52 and the intersection angle θs between the outer fiber cord 74B and the carcass cord 52 are equal to each other.

In the tire 2, from the viewpoint of being suitable for reducing the tensile force of the carcass cords 52, for instance, an intersection angle θm between the inner fiber cord 74A in the inner fiber reinforcing layer 66 and the outer fiber cord 74B in the outer fiber reinforcing layer 68 can be not less than 80 degrees and not greater than 160 degrees, as an example range.

In the tire 2, each core 32 can have a hexagonal cross-sectional shape (e.g., hexagonal or substantially hexagonal). The core 32 may be formed so as to have a rectangular cross-sectional shape (e.g., rectangular or substantially rectangular).

Each apex 34 can include the inner apex 34u and the outer apex 34 s. The inner apex 34u can be located radially outward of the core 32. The outer apex 34 s can be located radially outward of the inner apex 34u. The outer apex 34 s can be in contact with the inner apex 34u. The boundary between the inner apex 34u and the outer apex 34 s can extend between the outer end 46 of the inner apex 34u and the inner end 48 of the outer apex 34 s. In the cross-section of the tire 2 shown in FIG. 1, this boundary can be bent axially inward.

The inner apex 34u can extend radially outward from the core 32. In the cross-section of the tire 2 shown in FIG. 1, the inner apex 34u can be tapered outward in the radial direction.

The inner apex 34u can be formed from a crosslinked rubber. In the tire 2 according to one or more embodiments of the present disclosure, a complex elastic modulus E*u of the inner apex 34u can be in a range of not less than 40 MPa and not greater than 65 MPa, for example. The inner apex 34u can be relatively hard. And the inner apex 34u can contribute to the stiffness of the bead portion BP.

In one or more embodiments of the present disclosure, the complex elastic modulus E*u of the inner apex 34u can be measured using a viscoelasticity spectrometer under the following conditions according to the standards of JIS K6394. A complex elastic modulus E*s of the outer apex 34 s and a complex elastic modulus E*c of each chafer 10, which will be described later, can also be measured in the same manner.
Initial strain = 10%
Amplitude = ±1%
Frequency = 10 Hz
Deformation mode = tension
Measurement temperature = 70° C.

The outer apex 34 s can extend radially outward from the inner apex 34u. In the tire 2, the outer apex 34 s can have a relatively large thickness around the outer end 46 of the inner apex 34u. In the cross-section of the tire 2 shown in FIG. 1, the outer apex 34 s can be tapered inward in the radial direction, and can be tapered outward in the radial direction.

The outer apex 34 s can be formed from a crosslinked rubber. In the tire 2, the complex elastic modulus E*s of the outer apex 34 s can be in a range of not less than 3 MPa and not greater than 5 MPa, for instance. The outer apex 34 s can contribute to flexible deformation of the bead portion BP.

Each chafer 10 can be located (e.g., mainly located) axially outward of the bead 8. The chafer 10 can be located radially inward of the sidewall 6. The chafer 10 can come into contact with a seat S and a flange F of the rim R. The chafer 10 can cover the fiber reinforcing layer 22 from the outer side in the axial direction.

The chafer 10 can be formed from a crosslinked rubber. In the tire 2, the complex elastic modulus E*c of the chafer 10 can be in a range of not less than 7 MPa and not greater than 14 MPa, for instance. When the complex elastic modulus E*c of the chafer 10 is set to be not less than 7 MPa, generation of strain at the surface of the tire 2 due to protrusion of the chafer 10 can be prevented or minimized. From this viewpoint, the complex elastic modulus E*c of the chafer 10 can be not less than 9 MPa, for instance. When the complex elastic modulus E*c of the chafer 10 is set to be not greater than 14 MPa, occurrence of damage due to hardening of the chafer 10 can be prevented or minimized. From this viewpoint, the complex elastic modulus E* c of the chafer 10 not greater than 13 MPa, for instance.

In the tire 2 according to one or more embodiments of the disclosed subject matter, the minimum thickness of the chafer 10 between the core 32 and the flange F of the rim R can be in a range of not less than 2.5 mm and not greater than 6.0 mm, as an example range. In the tire 2, when the minimum thickness of the chafer 10 is set to be not less than 2.5 mm, occurrence of damage due to hardening of the chafer 10 can be prevented or minimized. When the minimum thickness of the chafer 10 is set to be not greater than 6.0 mm, generation of strain at the surface of the tire 2 due to protrusion of the chafer 10 can be prevented or minimized.

The tire 2 according to one or more embodiments of the disclosed subject matter can be produced as follows. In the production of the tire 2, first, an uncrosslinked tire, that is, a green tire 2r can be prepared by combining members such as the tread 4 and the sidewalls 6 on a forming machine.

In the production of the tire 2, the green tire 2r can be vulcanized and molded in a vulcanizing machine 100 shown in FIG. 9. The vulcanizing machine 100 can include a mold 102 and a bladder 104.

The mold 102 can have a cavity surface 106 on the inner surface thereof. The cavity surface 106 can come into contact with the outer surface of the green tire 2r and can shape the outer surface of the tire 2.

The mold 102 shown in FIG. 9 is a segmented mold, though embodiments of the present disclosure are not so limited to segmented molds. The mold 102 can include a tread ring 108, a pair of side plates 110, and a pair of bead rings 112 as components. In the mold 102, the above-described cavity surface 106 can be formed by combining these components. The mold 102 in FIG. 9 is in a state where these components are combined, that is, in a closed state.

In the mold 102, the tread ring 108 can form the tread 4 portion of the tire 2. The tread ring 108 can be composed of a large number of segments 114. Each side plate 110 can form the sidewall 6 portion of the tire 2, and each bead ring 112 can form the bead 8 portion of the tire 2.

The bladder 104 can be located inside the mold 102. The bladder 104 can be formed from a crosslinked rubber. The inside of the bladder 104 can be filled with a heating medium such as steam. Accordingly, the bladder 104 can expand. The bladder 104 shown in FIG. 9 is in a state where the bladder 104 is filled with the heating medium to be expanded. The bladder 104 can come into contact with the inner surface of the green tire 2r and can shape the inner surface of the tire 2. In the production of the tire 2, a rigid core made of metal, for instance, may be used instead of the bladder 104. The rigid core can have a toroidal outer surface. This outer surface can be approximated to the shape of the inner surface of the tire 2 in a state where the tire 2 is filled with air and the internal pressure of the tire 2 is maintained at 5% of the standardized internal pressure, for instance.

In the production of the tire 2, the green tire 2r can be placed into the mold 102 that can be set at a predetermined temperature. Thereafter, the mold 102 can be closed. The bladder 104 can expand by the filling with the heating medium and press the green tire 2r against the cavity surface 106 from the inside. The green tire 2r can be pressurized and heated inside the mold 102 for a predetermined time. Accordingly, the rubber composition of the green tire 2r can be cross-linked to obtain the tire 2.

As can be seen from FIG. 1, the tread 4 portion of the tire 2 can have a larger volume than the volume of the sidewall 6 portion. In the tire 2, in the tread 4 portion, the portion at the shoulder land portion 30s can have the maximum thickness. That is, in the tire 2, the portion at the shoulder land portion 30s can have a particularly large volume.

In the production of the tire 2, heat can be transmitted to the green tire 2r by the mold 102 and the bladder 104. In the green tire 2r, a portion having a small volume and a portion having a large volume can coexist. Heat can be relatively easily transmitted to the portion having a small volume, but heat may not be relatively easily transmitted to the portion having a large volume.

If a time for pressurizing and heating the green tire 2r, that is, a vulcanization time, is set based on the portion to which heat is easily transmitted, there may be a concern that the progress of vulcanization may be insufficient in the portion to which heat is not relatively easily transmitted. On the other hand, if the vulcanization time is set based on the portion to which heat is not easily transmitted, there may be a concern that the vulcanization may excessively proceed in the portion to which heat is relatively easily transmitted.

Meanwhile, in consideration of the environment, regulations regarding fuel economy have been introduced for vehicles. In order to meet these regulations, reduction of rolling resistance may be strongly required for tires.

If the vulcanization temperature is set to be lower than usual, the progress of excessive vulcanization can be suppressed, for instance, so that reduction of rolling resistance can be achieved. However, in this case, a long vulcanization time can be set, for instance, so that there may be a concern that the productivity of the tire may decrease.

As described above, in the tire 2, the holes 90 can be provided in each shoulder land portion 30s. Therefore, as shown in FIG. 9, the projections 94 can be provided to the mold 102 for the tire 2 in order to form the holes 90. Among the components of the mold 102, the segments 114 can form the tread 4 portion of the tire 2. Therefore, the projections 94 can be provided at portions, of the segments 114, which form the shoulder land portion 30s.

In the production of the tire 2, when the green tire 2r is pressurized and heated inside the mold 102, the above-described projections 94 can be inserted into portions, of the green tire 2r, corresponding to the shoulder land portions 30s (hereinafter, shoulder land portion-corresponding portions 96).

In the production of the tire 2, each projection 94 can be inserted to a deep position of the shoulder land portion-corresponding portion 96. Accordingly, the shoulder land portion-corresponding portion 96 can also be heated from the inside thereof. Therefore, the time for the shoulder land portion-corresponding portion 96 to reach an optimum vulcanization state can be shortened. In particular, in the production of the tire 2, the distal end of each projection 94 can be placed close to the belt 14. As a result, the green tire 2r can be more effectively heated since the belt 14 can include steel cords. The production of the tire 2 can shorten the vulcanization time. The tire 2 can thus contribute to improvement of productivity.

For the tire 2, the time required to form each shoulder land portion 30s portion can be shortened. The shortening of this time can suppress the progress of excessive vulcanization at the portion that has a relatively small volume and to which heat may be relatively easily transmitted. An increase in loss tangent (tanδ) due to excessive vulcanization can be suppressed, for instance, so that the tire 2 can achieve reduction of rolling resistance without relying on a rubber that has low-heat generation properties and inferior wear resistance.

In FIG. 5, a double-headed arrow L2 represents the distance in the radial direction from the outer end 60 of the steel reinforcing layer 20 to the end 54 of the turned-up portion 50b. A double-headed arrow L3 represents the distance in the radial direction from the end 54 of the turned-up portion 50b to the outer end 70 of the inner fiber reinforcing layer 66.

In the tire 2 according to one or more embodiments of the disclosed subject matter, the outer end 60 of the steel reinforcing layer 20 can be located so as to be separated radially inward from the end 54 of the turned-up portion 50b by the distance L2. Accordingly, concentration of strain on the outer end 60 of the steel reinforcing layer 20 can be suppressed. Since the bead portion BP can be flexibly bent, a force applied to the bead portion BP such that the bead portion BP falls down outward in the axial direction can be effectively alleviated. In the tire 2 according to one or more embodiments of the present disclosure, falling of the bead portion BP outward in the axial direction can be suppressed. From this viewpoint, for instance, the outer end 60 of the steel reinforcing layer 20 can be located inward of the end 54 of the turned-up portion 50b in the radial direction, and the distance L2 in the radial direction from the end 54 of the turned-up portion 50b to the outer end 60 of the steel reinforcing layer 20 can be not less than 10 mm and not greater than 15 mm, as an example range. According to one or more embodiments, the distance L2 can be equal to the above-described distance L1.

In the tire 2, the outer end 70 of the inner fiber reinforcing layer 66 can be located so as to be separated radially outward from the end 54 of the turned-up portion 50b by the distance L3. Accordingly, concentration of strain on the end 54 of the turned-up portion 50b can be suppressed. Since the bead portion BP can be flexibly bent, a force applied to the bead portion BP such that the bead portion BP falls down outward in the axial direction can be effectively alleviated. In the tire 2, falling of the bead portion BP outward in the axial direction can be suppressed. From this viewpoint, for instance, the outer end 70 of the inner fiber reinforcing layer 66 can be located outward of the end 54 of the turned-up portion 50b in the radial direction, and the distance L3 in the radial direction from the end 54 of the turned-up portion 50b to the outer end 70 of the inner fiber reinforcing layer 66 may be not less than 10 mm and not greater than 15 mm. From the viewpoint of effectively suppressing falling of the bead portion BP outward in the axial direction, for instance, the distance L3 can be equal to the above-described distance L1 and/or L2.

In light of the above description, according to one or more embodiments of the present disclosure, a heavy duty pneumatic tire 2 that can suppress occurrence of spot wear around each hole, provided in a shoulder land portion, to suppress occurrence of rib tear or chipping starting from the hole, while achieving shortening of a vulcanization time, can be obtained.

The embodiments disclosed above are merely illustrative in all aspects and are not restrictive. The technical scope of the present disclosure is not limited to the above-described embodiments, and all changes which come within the range of equivalency of the configurations recited in the claims are therefore intended to be included therein.

The above-described technology for suppressing occurrence of uneven wear can also be applied to various tires.

What is claimed is:

1. A heavy duty pneumatic tire comprising:
a pair of beads each having a core extending in a circumferential direction;
a carcass including a carcass ply having a body portion extending between one core and the other core and a pair of turned-up portions connected to the body portion and turned up around the cores from an inner side toward an outer side in an axial direction, the carcass ply including a plurality of carcass cords aligned with each other;
a tread radially outward of the body portion;
a belt radially outward of the body portion and radially inward of the tread;
a steel reinforcing layer turned up around the core, having an inner end inward of the body portion in the axial direction and an outer end outward of the turned-up portion in the axial direction, and including a plurality of steel cords aligned with each other; and
a fiber reinforcing layer including a plurality of fiber cords aligned with each other, wherein
at least three circumferential grooves are formed on the tread so as to be aligned in the axial direction, whereby at least four land portions are formed therein so as to be aligned in the axial direction,
among the at least three circumferential grooves, a circumferential groove located on each outermost side in the axial direction is a shoulder circumferential groove,
among the four land portions, a land portion located on each outermost side in the axial direction is a shoulder land portion,
a plurality of holes are in the shoulder land portion and extend from an outer surface thereof toward the belt,
each of the plurality of fiber cords is formed from a nylon fiber,
the fiber reinforcing layer includes an inner fiber reinforcing layer on an innermost side in the axial direction and an outer fiber reinforcing layer on the outermost side in the axial direction,
the inner fiber reinforcing layer covers an outer end of the steel reinforcing layer from the outer side in the axial direction, and
the outer fiber reinforcing layer covers an outer end of the inner fiber reinforcing layer from the outer side in the axial direction.

2. The heavy duty pneumatic tire according to claim 1, wherein a distance from each hole to an outer end of the shoulder land portion is not less than 0.12 times and not greater than 0.88 times a maximum width in the axial direction of the shoulder land portion.

3. The heavy duty pneumatic tire according to claim 1, wherein a depth of each hole is not less than ⅓ times and not greater than 1 times a depth of the shoulder circumferential groove.

4. The heavy duty pneumatic tire according to claim 1, wherein
an outer end of the outer fiber reinforcing layer is outward of an end of the turned-up portion in a radial direction, and
a distance in the radial direction to the outer end of the outer fiber reinforcing layer is not less than 1.4 times and not greater than 1.8 times a distance in the radial direction to the end of the turned-up portion.

5. The heavy duty pneumatic tire according to claim 1, wherein
the outer end of the inner fiber reinforcing layer is inward of an outer end of the outer fiber reinforcing layer in a radial direction,
a first distance in the radial direction to the outer end of the inner fiber reinforcing layer is smaller than a second distance in the radial direction to the outer end of the outer fiber reinforcing layer, and
a difference between the second distance and the first distance is not less than 10 mm and not greater than 15 mm.

6. The heavy duty pneumatic tire according to claim 1, wherein a total number of the plurality of fiber cords in the fiber reinforcing layer is not less than 20 and not greater than 70 per 50 mm width of the fiber reinforcing layer.

7. The heavy duty pneumatic tire according to claim 1, wherein
the fiber cords in the inner fiber reinforcing layer are tilted relative to the carcass cords,
the fiber cords in the outer fiber reinforcing layer are tilted relative to the carcass cords in a direction opposite to that of the fiber cords in the inner fiber reinforcing layer,
a first intersection angle between each fiber cord in the inner fiber reinforcing layer and each carcass cord is not less than 40 degrees and not greater than 80 degrees, and
a second intersection angle between each fiber cord in the outer fiber reinforcing layer and each carcass cord is not less than 40 degrees and not greater than 80 degrees.

8. The heavy duty pneumatic tire according to claim 1, wherein
the fiber cords in the inner fiber reinforcing layer are tilted relative to the carcass cords,
the fiber cords in the outer fiber reinforcing layer are tilted relative to the carcass cords in a direction opposite to that of the fiber cords in the inner fiber reinforcing layer, and
an intersection angle between each fiber cord in the inner fiber reinforcing layer and each fiber cord in the outer fiber reinforcing layer is not less than 80 degrees and not greater than 160 degrees.

9. The heavy duty pneumatic tire according to claim 1, further comprising:
a plurality of projections projecting outward from a bottom surface of one or more of the circumferential grooves, the plurality of projections per circumferential groove being spaced from each other in the circumferential direction.

10. The heavy duty pneumatic tire according to claim 9, wherein each of the plurality of projections is at a center portion in a width direction of a corresponding one of the circumferential grooves.

11. The heavy duty pneumatic tire according to claim 9, further comprising a plurality of lateral grooves connecting adjacent pairs of the circumferential grooves, wherein none of the plurality of projections are in plurality of lateral grooves.

12. The heavy duty pneumatic tire according to claim 1, wherein each of the circumferential grooves extends in the circumferential direction in a zig-zag pattern.

13. A heavy duty tire comprising:
a pair of beads each having a core extending in a circumferential direction;
a carcass including a carcass ply having a body portion extending between one core and the other core and a pair of turned-up portions connected to the body portion and turned up around the cores from an inner side toward an outer side in an axial direction, the carcass ply including a plurality of carcass cords;
a tread radially outward of the body portion;
a belt radially outward of the body portion and radially inward of the tread;
a steel reinforcing layer turned up around the core, having an inner end inward of the body portion in the axial direction and an outer end outward of the turned-up portion in the axial direction, and including a plurality of steel cords; and
a fiber reinforcing layer including a plurality of fiber cords, wherein
at least three circumferential grooves are formed on the tread so as to be aligned in the axial direction, whereby at least four land portions are formed therein so as to be aligned in the axial direction,
among the at least three circumferential grooves, a circumferential groove located on each outermost side in the axial direction is a shoulder circumferential groove,
among the four land portions, a land portion located on each outermost side in the axial direction is a shoulder land portion,
a plurality of holes are in the shoulder land portion and extend from an outer surface thereof toward the belt,
the fiber reinforcing layer includes an inner fiber reinforcing layer on an innermost side in the axial direction and an outer fiber reinforcing layer on the outermost side in the axial direction,
the inner fiber reinforcing layer covers an outer end of the steel reinforcing layer from the outer side in the axial direction, and
the outer fiber reinforcing layer covers an outer end of the inner fiber reinforcing layer from the outer side in the axial direction.

14. The heavy duty tire according to claim 13, wherein a distance from each hole to an outer end of the shoulder land portion is not less than 0.12 times and not greater than 0.88 times a maximum width in the axial direction of the shoulder land portion.

15. The heavy duty tire according to claim 13, wherein a depth of each hole is not less than ⅓ times and not greater than 1 times a depth of the shoulder circumferential groove.

16. The heavy duty tire according to claim 13, wherein
the outer end of the inner fiber reinforcing layer is inward of an outer end of the outer fiber reinforcing layer in a radial direction,
a first distance in the radial direction to the outer end of the inner fiber reinforcing layer is smaller than a second distance in the radial direction to the outer end of the outer fiber reinforcing layer, and
a difference between the second distance and the first distance is not less than 10 mm and not greater than 15 mm.

17. The heavy duty tire according to claim 13, wherein a total number of the plurality of fiber cords in the fiber reinforcing layer is not less than 20 and not greater than 70 per 50 mm width of the fiber reinforcing layer.

18. The heavy duty tire according to claim 13, wherein
the fiber cords in the inner fiber reinforcing layer are tilted relative to the carcass cords,
the fiber cords in the outer fiber reinforcing layer are tilted relative to the carcass cords in a direction opposite to that of the fiber cords in the inner fiber reinforcing layer,
a first intersection angle between each fiber cord in the inner fiber reinforcing layer and each carcass cord is not less than 40 degrees and not greater than 80 degrees, and
a second intersection angle between each fiber cord in the outer fiber reinforcing layer and each carcass cord is not less than 40 degrees and not greater than 80 degrees.

19. The heavy duty tire according to claim 13, wherein
the fiber cords in the inner fiber reinforcing layer are tilted relative to the carcass cords,
the fiber cords in the outer fiber reinforcing layer are tilted relative to the carcass cords in a direction opposite to that of the fiber cords in the inner fiber reinforcing layer, and
an intersection angle between each fiber cord in the inner fiber reinforcing layer and each fiber cord in the outer fiber reinforcing layer is not less than 80 degrees and not greater than 160 degrees.

20. The heavy duty tire according to claim 13, further comprising:
a plurality of projections projecting outward from a bottom surface of one or more of the circumferential grooves; and
a plurality of lateral grooves connecting adjacent pairs of the circumferential grooves,
wherein the plurality of projections per circumferential groove are spaced from each other in the circumferential direction,
wherein none of the plurality of projections are in plurality of lateral grooves, and
wherein each of the circumferential grooves extends in the circumferential direction in a zig-zag pattern.
